(19) United States
(12) Patent Application Publication
(10) Pub. No.: US 2023/0004938 A1
(43) Pub. Date: Jan. 5, 2023

(54) Detecting Inactive Projects Based On Usage Signals And Machine Learning

(71) Applicant: Google LLC, Mountain View, CA (US)

(72) Inventor: Yun Teng, Mountain View, CA (US)

(73) Assignee: Google LLC, Mountain View, CA (US)

(21) Appl. No.: 17/810,090

(22) Filed: Jun. 30, 2022

Related U.S. Application Data
(60) Provisional application No. 63/202,966, filed on Jul. 1, 2021.

(51) Int. Cl. G06Q 10/10; G06N 5/02

(52) U.S. Cl. CPC G06Q 10/103; G06N 5/022

(57) ABSTRACT

A method for detecting inactive projects based on usage signals and machine learning includes receiving a plurality of cloud computing projects each associated with a client device of a cloud computing environment. For each respective cloud computing project of the plurality of cloud computing projects associated with the client device of the cloud computing environment, the method also includes determining a similarity measurement between the respective cloud computing project and a reference cloud computing project, and generating a respective project usage score for the respective cloud computing project based on the similarity measurement determined between the respective cloud computing project and the reference cloud computing project. The method also includes communicating, to the client device of the cloud computing environment, one or more of the respective project usage scores generated for the plurality of cloud computing projects.

### CROSS REFERENCE TO RELATED APPLICATIONS

This U.S. patent application claims priority under 35 U.S.C. § 119(e) to U.S. Provisional Application 63/202,966, filed on Jul. 1, 2021. The disclosure of this prior application is considered part of the disclosure of this application and is hereby incorporated by reference in its entirety.

### TECHNICAL FIELD

This disclosure relates to detecting inactive projects based on usage signals and machine learning.

### BACKGROUND

Users of a cloud computing platform, such as a business, can have many cloud-based projects running concurrently. These projects can be related to various tasks that can be implemented in the cloud, such as data management and/or machine learning. As personnel and objectives of the business change over time, it can be difficult for the business to manage the portfolio of cloud-based projects.

### SUMMARY

One aspect of the disclosure provides a computer-implemented method for using machine learning to detect inactive projects based on usage. The computer-implemented method, when executed by data processing hardware, causes the data processing hardware to perform operations that include receiving a plurality of cloud computing projects each associated with a client device of a cloud computing environment. The operations also include, for each respective cloud computing project of the plurality of cloud computing projects associated with the client device of the cloud computing environment, determining a similarity measurement between the respective cloud computing project and a reference cloud computing project and generating a respective project usage score for the respective cloud computing project based on the similarity measurement determined between the respective cloud computing project and the reference cloud computing project. The operations further include communicating one or more respective project usage scores for the plurality of cloud computing projects to the client device of the cloud computing environment.

Implementations of the disclosure may include one or more of the following optional features. In some implementations, the operations further include, for each respective cloud computing project, generating a respective rank of the respective cloud computing project among the plurality of cloud computing projects based on the respective project usage scores generated for each respective cloud computing project. In these implementations, communicating the one or more respective project usage scores for the plurality of cloud computing projects to the client device may include, for each respective cloud computing project, communicating the respective project usage score for the respective cloud computing project along with the respective rank of the respective cloud computing project among the plurality of cloud computing projects.

In some implementations, the operations further include determining that one of the plurality of cloud computing projects satisfies a project threshold based on the respective project usage score of the one of the plurality of cloud computing projects. The project threshold represents a predetermined activity level that corresponds to an active cloud computing project. In these implementations, the operations may further include generating a remediation recommendation for the one of the plurality of cloud computing projects that satisfies the project threshold and communicating the remediation recommendation to the client device of the cloud computing environment. In some of these implementations, the remediation recommendation may include a project cleanup recommendation or a project inspection recommendation.

In some examples, determining the similarity measurement between the respective cloud computing project and the reference cloud computing project includes comparing a first value of a cloud computing project usage metric for the respective cloud computing project and a second value of the cloud computing project usage metric for the reference cloud computing project. Here, the cloud computing project usage metric may include at least one of a billing service metric, a number of application programming interface (API) calls, or an identity and access management (IAM) metric.

In some implementations, determining the similarity measurement between the respective cloud computing project and the reference cloud computing project includes comparing a first set of values of a plurality of cloud computing project usage metrics for the respective cloud computing project and a second set of values of the plurality of cloud computing project usage metrics for the reference cloud computing project. In these implementations, the plurality of cloud computing project usage metrics may correspond to more than one of a billing service metric, a number of application programming interface (API) calls, or an identity and access management (IAM) metric. Further, the reference cloud computing project may have zero project usage during a lifetime of the reference cloud computing project.

Another aspect of the disclosure provides a system for using machine learning to detect inactive projects based on usage. The system includes data processing hardware and memory hardware in communication with the data processing hardware. The memory hardware stores instructions that when executed on the data processing hardware cause the data processing hardware to perform operations. The operations include receiving a plurality of cloud computing projects each associated with a client device of a cloud computing environment. The operations also include, for each respective cloud computing project of the plurality of cloud computing projects associated with the client device of the cloud computing environment, determining a similarity measurement between the respective cloud computing project and a reference cloud computing project and generating a respective project usage score for the respective cloud computing project based on the similarity measurement determined between the respective cloud computing project and the reference cloud computing project. The operations further include communicating one or more respective project usage scores for the plurality of cloud computing projects to the client device of the cloud computing environment

This aspect may include one or more of the following optional features. In some implementations, the operations further include, for each respective cloud computing project, generating a respective rank of the respective cloud computing project among the plurality of cloud computing projects based on the respective project usage scores generated for each respective cloud computing project. In these implementations, communicating the one or more respective project usage scores for the plurality of cloud computing projects to the client device may include, for each respective cloud computing project, communicating the respective project usage score for the respective cloud computing project along with the respective rank of the respective cloud computing project among the plurality of cloud computing projects.

In some implementations, the operations further include determining that one of the plurality of cloud computing projects satisfies a project threshold based on the respective project usage score of the one of the plurality of cloud computing projects. The project threshold represents a predetermined activity level that corresponds to an active cloud computing project. In these implementations the operations may further include generating a remediation recommendation for the one of the plurality of cloud computing projects that satisfies the project threshold and communicating the remediation recommendation to the client device of the cloud computing environment. In some of these implementations, the remediation recommendation may include a project cleanup recommendation or a project inspection recommendation.

In some examples, determining the similarity measurement between the respective cloud computing project and the reference cloud computing project includes comparing a first value of a cloud computing project usage metric for the respective cloud computing project and a second value of the cloud computing project usage metric for the reference cloud computing project. Here, the cloud computing project usage metric may include at least one of a billing service metric, a number of application programming interface (API) calls, or an identity and access management (IAM) metric.

In some implementations, determining the similarity measurement between the respective cloud computing project and the reference cloud computing project includes comparing a first set of values of a plurality of cloud computing project usage metrics for the respective cloud computing project and a second set of values of the plurality of cloud computing project usage metrics for the reference cloud computing project. In these implementations, the plurality of cloud computing project usage metrics may correspond to more than one of a billing service metric, a number of application programming interface (API) calls, or an identity and access management (IAM) metric. Further, the reference cloud computing project may have zero project usage during a lifetime of the reference cloud computing project.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for using machine learning to detect inactive projects based on usage.

FIG. 2 is a schematic view of an unattended project controller detecting inactive projects.

FIG. 3A is a schematic view of the unattended project controller generating a remediation recommendation based on a first project usage metric.

FIG. 3B is a schematic view of the unattended project controller generating a remediation recommendation based on a second project usage metric.

FIG. 4 is a schematic view of a machine learning model generating clusters for the projects.

FIG. 5 is a flowchart of an exemplary arrangement of operations for a method for using machine learning to detect inactive projects based on usage.

FIG. 6 is a flowchart of an exemplary arrangement of operations for a method for using machine learning to provide recommendations for projects based on usage.

FIG. 7 is a schematic view of an example computing device that may be used to implement the systems and methods described herein.

Like reference symbols in the various drawings indicate like elements

### DETAILED DESCRIPTION

Businesses can use cloud computing environments to implement a large number of different projects. These projects can span in scope from one-off prototypes to applications that are essential for the business. Further, each project can be assigned to a number of managers and/or employees (i.e., project owners). Over time, as project owners switch roles or leave the business, as new projects are created, and as business objectives change, it can be difficult to manage the project portfolio and determine which projects are important and which projects are no longer needed. By keeping unused projects in the cloud computing environment, the business can face unnecessary costs, security exposure, and operational overhead.

While it may be straightforward to identify unused projects (e.g., projects with zero usage during an observation period), it may be difficult to identify projects that have activity without utility. For example, a user tests a file or function in a project without cleaning up after testing. In this example, the project may appear to be active although the project is actually inactive and unneeded. These “active” projects may increase cost and pose greater security risks versus completely unused projects.

Currently, there are rule-based methods for classifying projects (i.e., active or inactive). However, these known methods require manual inspection and do not scale. Further, it can be difficult to find a rule-based method that applies to multiple businesses. Implementations herein use machine learning to detect inactive projects in a cloud computing environment based on usage signals. In other words, a machine learning algorithm may analyze a project portfolio to determine which projects are active and which are inactive using one or more usage signals as features or inputs. The projects can then each be given a score indicating the respective project's usage and/or the projects can be ranked based on usage. In some implementations, the system generates recommendations on how to manage each project (e.g., delete, inspect, cleanup).

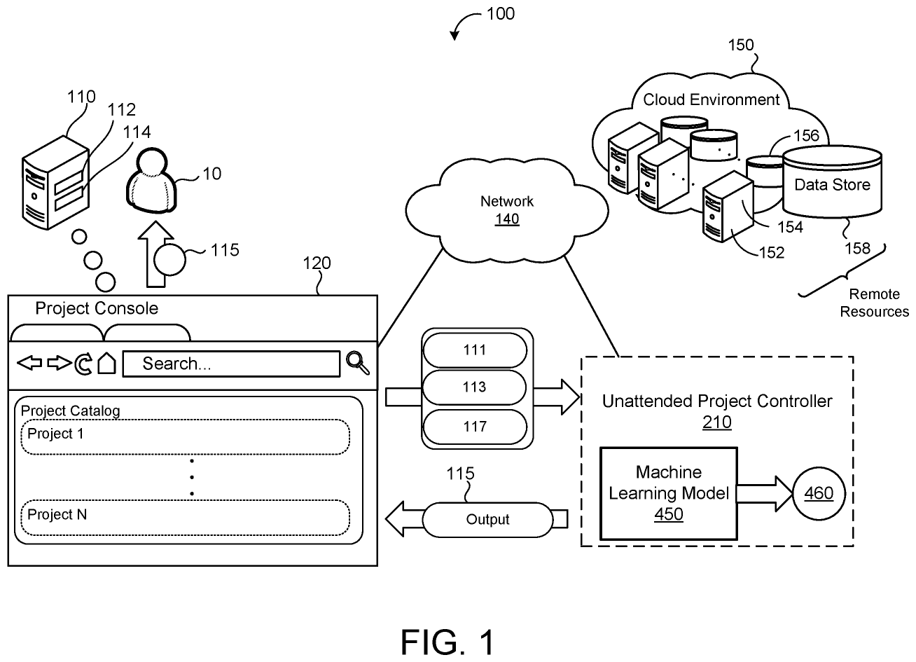

FIG. 1 is a schematic view of an example system 100 for using machine learning to detect inactive projects based on usage. The system 100 includes a client 10 using a client device 110 to access a project console 120 with a plurality of cloud computing projects 111. The client device 110 includes data processing hardware 112 and memory hardware 114. In some implementations, the data processing hardware 112 executes at least a portion of an unattended project controller 210. For example, the client device 110 executes a portion of the unattended project controller 210 locally while a remaining portion of the unattended project controller 210 executes on a cloud computing environment 150. The client device 110 can be any computing device capable of communicating with the cloud computing environment 150 through, for example, a network 140. The client device 110 includes, but is not limited to, desktop computing devices and mobile computing devices, such as laptops, tablets, smart phones, smart speakers/displays, smart appliances, internet-of-things (IoT) devices, and wearable computing devices (e.g., headsets and/or watches).

In some implementations, the client device 110 is in communication with the cloud computing environment 150 (also referred to herein as a remote system 150) via the network 140. The cloud computing environment 150 may be a single computer, multiple computers, or a distributed system (e.g., a cloud environment) having scalable/elastic resources 152 including computing resources 154 (e.g., data processing hardware) and/or storage resources 156 (e.g., memory hardware). A data store 158 (i.e., a remote storage device) may be overlain on the storage resources 156 to allow scalable use of the storage resources 156 by one or more client device 110 or the computing resources 154. The clouding computing environment 150 may be used to store and host a number of cloud computing projects 111 (herein also referred to as just projects 111). Further, the cloud computing environment 150 may execute some or all of the unattended project controller 210 which includes a machine learning model 450. The project console 120 may execute locally on the client device 110 (e.g., on the data processing hardware 112) or remotely (e.g., at the remote system 150) or any combination thereof. Likewise, the unattended project controller 210 may be stored locally at the client device 110 or stored at the remote system 150 (e.g., at the data store 158) or any combination thereof.

In some examples, each cloud computing project 111 is a set of configuration settings that defines how an application interacts with services and resources associated with the cloud computing environment 150. In this sense, a project 111 organizes cloud computing resources. A project 111 may consist of a set of users, a set of application programming interfaces (APIs), billing authentication, and/or various means of monitoring the APIs. For instance, cloud storage buckets and objects along with user permissions for accessing these buckets and objects may reside in a particular project 111.

Often, a client 10 of the cloud computing environment 150 can create multiple projects 111 and use a central hub/interface, such as the project console 120, to organize and to manage each project 111 and the resources associated with each respective project 111. In this sense, a project 111 functions as a resource organizer. For example, the client 10 may be developing a new version of a client resource (e.g., an application) and have a test project 111 for the new version that has not been yet released to function as a test environment and a production project 111 for the version of the client resource that is already in use/production.

Each project 111 may use identity and access management (IAM) to grant the ability to particular users (e.g., employees) to manage and to work on a project 111. In this respect, a client 10, when granted permission/access, becomes a member of the project 111. The IAM may also allow a project 111 to have varying degrees of access, member roles, and/or other management policies.

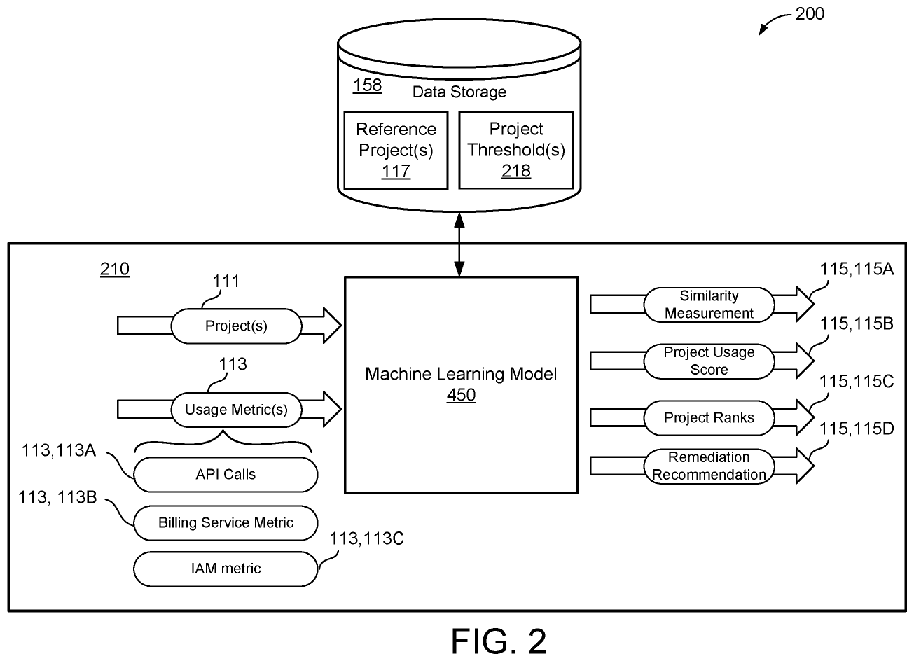

Unfortunately, with the ability to generate multiple projects 111, clients 10 often have projects 111 with varying degrees of activity ranging from inactive or unattended projects to active projects. Because a project 111 may occupy cloud computing resources, these inactive projects may have implications for the client 10 with respect to cost and/or security. As such, the unattended project controller 210 is configured to assess the activity level of one or more of the projects 111 for the client 10 and to generate an output 115, such as a recommendation, or lack thereof, as to whether the client 10 should perform some housekeeping or other action with regard to a particular project 111 or group of projects 111. For instance, the unattended project controller 210 identifies that the project 111 is inactive and generates a remediation recommendation 115D (FIG. 2) to clean up the project 111. In another example, the unattended project controller 210 identifies that the project 111 has missing or inactive members and the output 115 recommends reassigning roles to reconcile these ownership issues.

To generate the output 115, the unattended project controller 210 collects or receives one or more usage metrics 113 for a particular project 111 and determines whether the one or more usage metrics 113 indicates that the unattended project controller 210 should generate a particular output 115. Some examples of usage metrics 113 include a billing service metric, a number of application programming interface (API) calls, or an identity and access management (IAM) metric.

In some configurations, the unattended project controller 210 uses the machine learning model 450 when generating the output 115. For example, the machine learning model receives a project 111 and its associated usage metric(s) 113 and generates the output 115 predicting a level of activity for the project 111 based on reference projects 117 that the machine learning model 450 is provided. In these examples, the machine learning model 450 may be configured to perform clustering where the model 450 groups the project 111 into a cluster 460 that represents a level of activity for the project 111. For instance, the model 450 may cluster a received project 111 into an inactive cluster 460 or an active cluster 460. In some implementations, the inactive cluster 460 has a centroid that represents a reference project 117 with a designated level of activity to represent the cluster 460. For example, an inactive cluster 460 has a centroid represented by a reference project 117 with zero activity (i.e., completely inactive). When a project 111 received by the model 450 is classified into a cluster 460, such as the inactive cluster 460, the model 450 may compare the received project 111 to the reference project 117 to determine a relative level of activity (or inactivity) for the received project 111. For instance, the model 450 or recommender uses a similarity function that compares usage metric(s) 113 of the reference project 117 to usage metric(s) 113 of the received project 111. Here, the unattended project controller 210 may then score the received project 111 based on its comparison to the reference project 117 to generate an output 115 of a usage score for the received project 111. The recommender may then use the usage score to generate its recommendation for the project.

FIG. 2 is a schematic view 200 of the unattended project controller 210 detecting inactive projects 111. The unattended project controller 210 may receive one or more inputs including projects 111, usage metrics 113, 113A-C, reference projects 117, project thresholds 218 (also referred to herein as activity thresholds) and/or implement the machine learning model 450 to process the one or more inputs 111, 113 to generate one or more outputs 115, 115A-D. The projects 111 may include a set of cloud computing projects 111 owned by a business in a cloud computing environment (e.g., cloud computing environment 150 of FIG. 1) and the usage metrics 113 correspond to each project 111. The machine learning model 450 may receive some or all of the inputs 111, 113, 117, 218 from a data storage, such as data storage 158 of the cloud computing environment 150 of FIG. 1.

In some implementations, the usage metrics 113 include a number of API calls 113, 113A that have been made for the corresponding project 111. Further, the usage metrics 113 may include a billing service metric 113, 113B and/or an identity and access management (IAM) metric 113, 113C corresponding to a project 111. In some implementations, the usage metrics 113 are collected from a customizable period of time. For example, a business may want to know which projects are active in the last year, the last three years, etc., and the usage metrics 113 may be obtained according to the desired timeline. The above list of usage metrics 113 is for illustrative purposes and is not intended to be limiting. Any suitable metrics (e.g., access frequency, access types, access sizes, etc.) can be used to as project usage metrics 113.

The machine learning model 450 may process the projects 111 and the corresponding project usage metric 113 based on either one, or both, of the reference projects 117 and/or the project threshold score 218 to produce outputs 115, 115A-D. Any of the outputs 115 may be transmitted to a client device (i.e., client device 110 of FIG. 1) for display to a client 10. As an example, the machine learning model 450 may generate a similarity measurement 115A for each project 111 based one or more received reference projects 117. The similarity measurement 115A may indicate a level of similarity between the project 111 and the corresponding reference project 117. For example, the higher the similarity measurement 115A, the more similar the project 111 and the corresponding reference project 117 are. In some implementations, the similarity measurement 115A between the respective cloud computing project 111 and the reference cloud computing project 117 includes comparing a first set of values of a plurality of cloud computing project usage metrics 113 for the respective cloud computing project 111 and a second set of values of the plurality of cloud computing project usage metrics 113 for the reference cloud computing project 117. In these implementations, the similarity measurement 115A indicates the similarity between the respective project usage metrics 113 of each project 111 with the reference project 117. The similarity measurement 115A may be a percentage, a numeric score, etc. In some implementations, the machine learning model 450 determines a project usage score 115B based on the similarity measurement 115A. For example, the project usage score 115B may be a scaled (i.e., a log transformation) version of the similarity measurement 115A. In some implementations the similarity measurement 115A and the project usage score 115B are calculated independently of each other. For example, the project usage score 115B may be based on the project usage metrics 113 and indicate a level of activity of the project 111.

The output 155, in some examples, includes one or more project ranks 115C (also referred to herein as “rankings 115C”). The project ranks 115C rank one or more of the projects 111 among the plurality of cloud computing projects 111, where the highest ranked projects 111 are the most likely to be active and the lowest ranked projects 111 are the most likely to be inactive/unattended. In some implementations, the project ranks 115C are based on the similarity measurement 115A or the project usage score 115B. In other implementations, the project ranks 115C is based on a combination of the similarity measurement 115A and the project usage score 115B.

In some implementations, the output 115 includes one or more remediation recommendations 115D. The remediation recommendation 115, 115D includes a recommendation to the client 10 on how to manage a project 111. The remediation recommendation 115D can be any suitable recommendation for a project such as a delete recommendation, a project cleanup recommendation, a project inspection recommendation, etc. The remediation recommendation 115D may be based on any suitable combination of the similarity measurement 115A, project usage score 115B, and/or project ranks 115C. For example, when a project 111 has a high similarity score 115A with a reference project 117 corresponding to a level of inactivity (i.e., the reference project represents an inactive project), that project 111 may have a remediation recommendation of “delete” or “cleanup.” Alternatively, when a project 111 has a high similarity score 115A with a reference project 117 corresponding to a level of activity (i.e., the reference project represents an active project), that project 111 may have a remediation recommendation of “reclaim ownership” or “inspect.” In some implementations, the remediation recommendation 115D is based on the project usage score 115B. For example, the unattended project controller 210 provides a cleanup remediation recommendation 115D for the bottom ten percentile of projects 111 based on the project usage score 115B. Further, the unattended project controller 210 may divide projects 111 into groups based on the project usage score 115D, and each group may be given the same remediation recommendations 115D. Alternatively, the unattended project controller 210 instead implements the project ranks 115C to determine the remediation recommendation 115D based (e.g., the bottom ten percentile based on project rank 115C receive a cleanup recommendation).

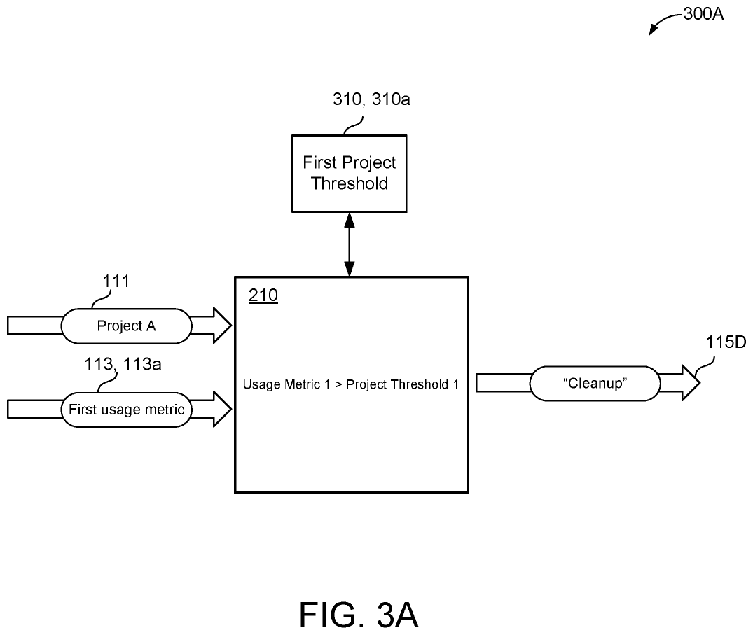

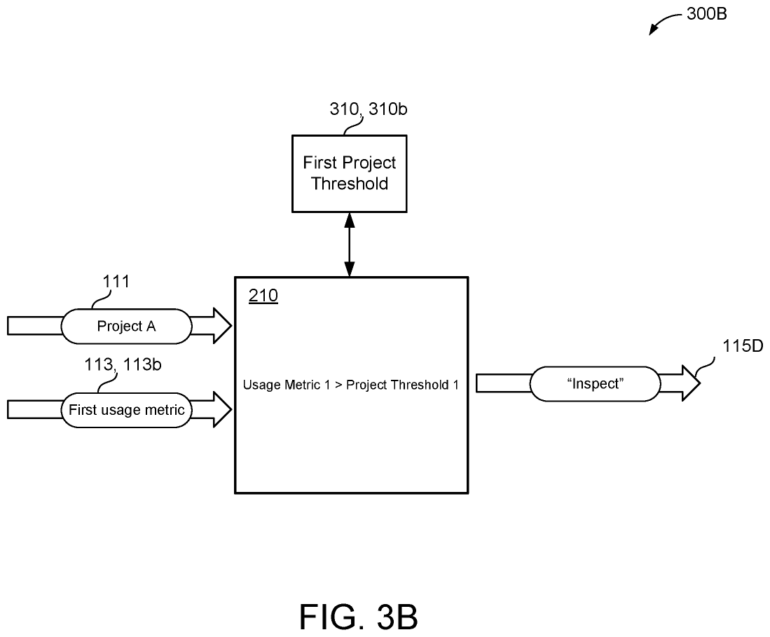

FIG. 3A includes a schematic view 300A of the unattended project controller generating a remediation recommendation 115D based on a first project usage metric. In some implementations, the remediation recommendation 115D is based on one or more comparisons between usage metrics 113 of a project 111 to project thresholds 218. Referring to the illustrative example of FIG. 3A, the unattended project controller 210 receives project A 111 and a first usage metric 113, 113a along with a first project threshold 300, 300a. The unattended project controller 210 determines that the first usage metric 113a satisfies the first project threshold 318 (e.g., the first usage metric 113a is greater than the first project threshold 300a). The unattended project controller 210 thus, in this example, generates a remediation recommendation 115D of “cleanup,” indicating that project A 111 is inactive. At this point, the remediation recommendation 115D may be transmitted to client device 110 for display to the client 10.

FIG. 3B is a schematic view 300B of the unattended project controller generating a remediation recommendation 115D based on a second project usage metric 113, 113b. In the illustrative example of FIG. 3B, the unattended project controller 210 receives project A 111 and a second usage metric 113b along with a second project threshold 300, 300b. The unattended project controller 210 determines that the second usage metric 113b satisfies the second project threshold 300b (i.e., the second usage metric 113b is greater than the second project threshold 300b). The unattended project controller 210 thus alters the remediation recommendation 115D to “inspect,” indicating that project A 111 may be active. At this point, the altered remediation recommendation 115D may be transmitted to the client device 110 for display to the client 10.

In some implementations, the first usage metric 113a is different than the second usage metric 113b. For example, the first usage metric 113a may be any of API calls 113A, Billing Service Metric 113B, or IAM metric 113C, while the second usage metric 113b is a different usage metric 113 than the first usage metric 113a.

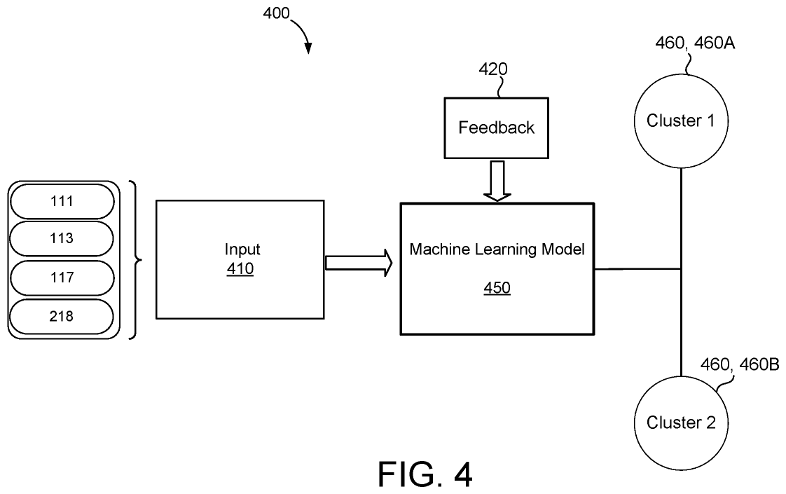

FIG. 4 is a schematic view 400 of an example machine learning model 450 for detecting inactivity of one or more projects 111 based on usage. In some implementations, the machine learning model 450 is a self-supervised or unsupervised machine learning model, which is a machine learning model that receives unlabeled data as input 410. Using a self-supervised machine learning model 450 can be advantageous as it can be difficult to received label data training data for inactive and active cloud based projects 111. Further, even if labeled data was available, it might not be helpful to train a single machine learning model, as different customers will have different preferences as to what constitutes an active project and what constitutes an inactive project. Thus, it can be impractical to implement a singular model trained on a large set of data for all customers. A self-supervised learning model can be tailored based on the business, which will result in more accurate recommendations.

Here, the self-supervised machine learning model 450 can receive unlabeled data as an input 410 (i.e., projects 111, project usage metrics 113, reference projects 117, and project thresholds 218) and produce two clusters 460, 460A-B of projects 111 based on two reference projects 117. In some implementations, the first cluster 460A is based on one or more reference projects 117 corresponding to inactivity (i.e. inactive or unattended projects) and a second cluster 460B is based on one or more reference projects 117 corresponding to activity (i.e., active projects). For example, the reference project 117 based on inactivity may have a corresponding usage metric 113 indicating zero project usage during its lifetime. In another example, the reference project 117 based on activity may be chosen by a client 10 indicating sufficient usage to be deemed active.

The machine learning model 450 may process each project 111 individually to generate the clusters 460A-B. In some implementations, the machine learning model 450 processes the projects 111 in an iterative fashion for a number of cycles until the clusters 460 are sufficiently separated (i.e., each project 111 is within a certain distance from either cluster 460A-B). In some implementations, the machine learning model 450 receives feedback 420 which can be used to regenerate the clusters 460. For example, a project 111 that was placed in the cluster 460A with the reference project 117 corresponding to inactivity may be manually re-labeled as active. In turn, the machine learning model 450 may adjust one or more parameters such that the project 111, and similar projects 111, will be placed in the active cluster 460B in future iterations. As another example, if a project 111 receives a remediation recommendation 115D indicating that the project 111 needs a cleanup and that project 111 remains unchanged, the machine learning model 450 may adjust so that the project 111 will not be placed in the cluster 460A where projects are recommended to be cleaned up (i.e., inactive).

In some implementations, one or more outputs 115 are derived based on the clusters 460. For example, a similarity measurement 115A may be based on the distance in the cluster 460 between a project 111 and the corresponding reference project 117. Here, the projects 111 placed closest in the cluster to the reference project 117 would have the largest similarity measurement 115A. Further, the project usage score 115B may be based on the similarity measurement 115A. For example, the project usage score 115B is based on the percentile rank of the similarity measurement 115A. In other implementations, the project ranks 115C are based on the clusters 460. For example, the projects 111 that belong in the cluster 460A corresponding to the reference project 117 indicating inactivity are ranked low while the projects 111 in the cluster 460B are ranked high. The project rank 115C may also be based on the distance between the project 111 and its corresponding reference project 117, where the projects 111 placed closer to their corresponding reference project 117 are ranked higher in the active cluster 460B and lower in the inactive cluster 460A.

In some implementations the remediation recommendation 115D can be based on the clusters 460A and 460B and/or any of the similarity measurement 115A, project usage score 115B, and project rank 115C. For example, any projects 111 that are placed in the inactive cluster 460A are labeled with the remediation recommendation 115D of “clean up,” while the projects 111 placed in the active cluster 460B may be given the remediation recommendation 115D of “confirm ownership.” Further, if a project 111 is not sufficiently close to a cluster 460 (i.e., farther than a predetermined distance away from either reference project 117), that project 111 may be give a remediation recommendation of “inspect.”

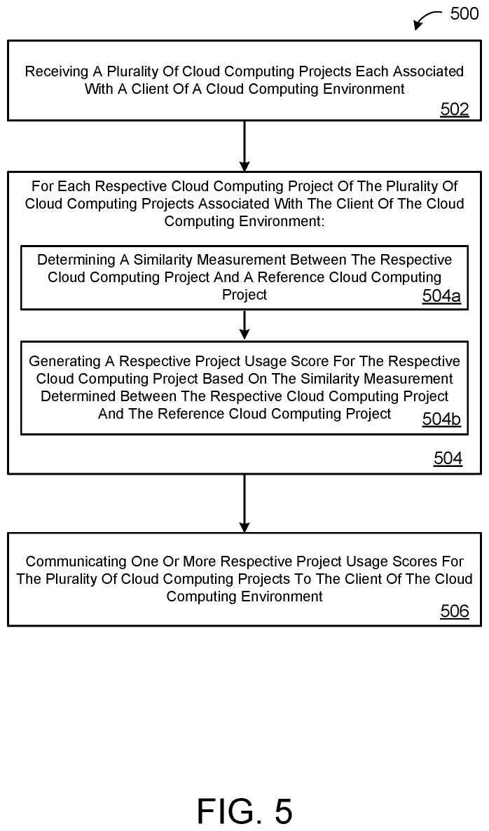

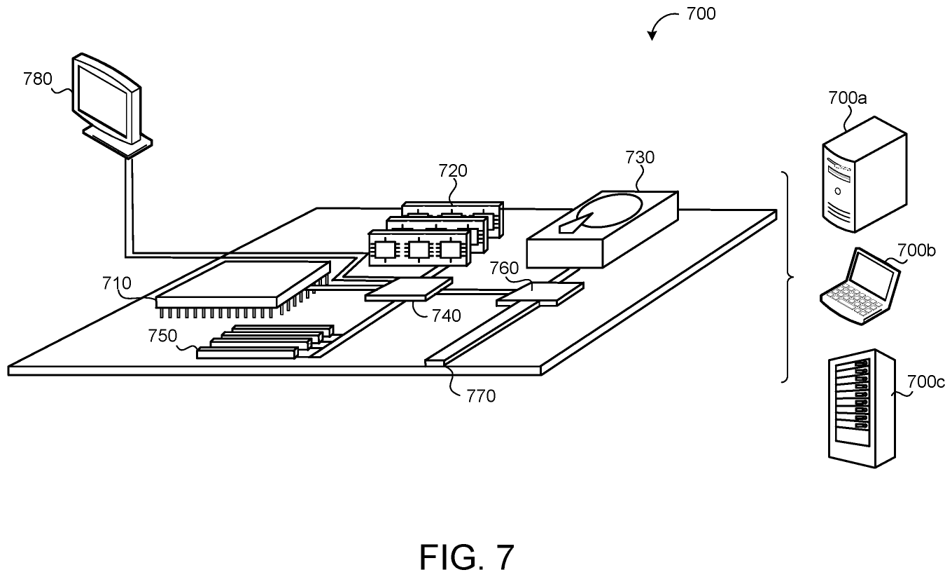

FIG. 5 is a flowchart of an exemplary arrangement of operations for a method 500 for using machine learning to detect inactive projects based on usage. The method 500 may be performed, for example, by various elements of the system 100 of FIG. 1 or computing device 700 of FIG. 7. For instance, the method 500 may execute on the data processing hardware 154 of the remote system 150, the data processing hardware 112 of the client device 110, the data processing hardware 710 of computing device 700, or some combination thereof. At operation 502, the method 500 includes receiving a plurality of cloud computing projects 111 each associated with a client 10 of a cloud computing environment 150. At operation 504, for each respective cloud computing project 111 of the plurality of cloud computing projects 111 associated with the client 10 of the cloud computing environment 150, the method 500 includes determining, at operation 504a, a similarity measurement 115A between the respective cloud computing project 111 and a reference cloud computing project 117 and generating, at operation 504b, a respective project usage score 115B for the respective cloud computing project 111 based on the similarity measurement 115A determined between the respective cloud computing project 111 and the reference cloud computing project 117. At operation 506, the method 500 includes communicating one or more respective project usage scores 115B for the plurality of cloud computing projects 111 to the client 10 of the cloud computing environment 150.

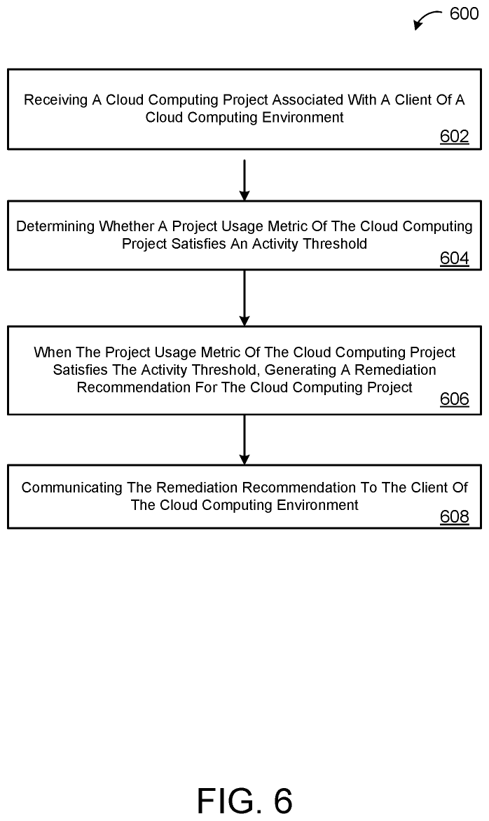

FIG. 6 is a flowchart of an exemplary arrangement of operations for a method 600 for using machine learning to provide recommendations for projects based on usage. The method 600 may be performed, for example, by various elements of the system 100 of FIG. 1 or computing device 700 of FIG. 7. For instance, the method 600 may execute on the data processing hardware 154 of the remote system 150, the data processing hardware 112 of the client device 110, the data processing hardware of computing device 700, or some combination thereof. At operation 602, the method 600 includes receiving a cloud computing project 111 associated with a client 10 of a cloud computing environment 150. At operation 604, the method 600 includes determining whether a project usage metric 113 of the cloud computing project 111 satisfies an activity threshold 218. When the project usage metric 113 of the cloud computing project 111 satisfies the activity threshold 218, at operation 606, the method 600 includes generating a remediation recommendation 115D for the cloud computing project 111. At operation 608, the method 600 includes communicating the remediation recommendation 115D to the client device 110 of the cloud computing environment 150.

FIG. 7 is a schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710 (interchangeably referred to as “data processing hardware 710”), memory 720 (e.g., memory hardware), a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. Data processing hardware 710 may include the data processing hardware 112 of the user device 110 or the data processing hardware 154 of the remote system 150 of FIG. 1. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed by data processing hardware causes the data processing hardware to perform operations comprising:
receiving a plurality of cloud computing projects each associated with a client device of a cloud computing environment;
for each respective cloud computing project of the plurality of cloud computing projects associated with the client device of the cloud computing environment:
determining a similarity measurement between the respective cloud computing project and a reference cloud computing project; and
generating a respective project usage score for the respective cloud computing project based on the similarity measurement determined between the respective cloud computing project and the reference cloud computing project; and
communicating, to the client device of the cloud computing environment, one or more of the respective project usage scores generated for the plurality of cloud computing projects.

2. The method of claim 1, wherein:
the operations further comprise, for each respective cloud computing project, ranking the respective cloud computing project among the plurality of cloud computing projects based on the respective project usage scores generated for each respective cloud computing project; and
communicating the one or more respective project usage scores for the plurality of cloud computing projects to the client device comprises, for each respective cloud computing project, communicating the respective project usage score for the respective cloud computing project along with the ranking of the respective cloud computing project among the plurality of cloud computing projects.

3. The method of claim 1, wherein the operations further comprise:
determining that one of the plurality of cloud computing projects satisfies a project threshold based on the respective project usage score of the one of the plurality of cloud computing projects, the project threshold representing a predetermined activity level that corresponds to an active cloud computing project;
generating a remediation recommendation for the one of the plurality of cloud computing projects that satisfies the project threshold; and
communicating the remediation recommendation to the client device of the cloud computing environment.

4. The method of claim 3, wherein the remediation recommendation comprises a project cleanup recommendation.

5. The method of claim 3, wherein the remediation recommendation comprises a project inspection recommendation.

6. The method of claim 1, wherein determining the similarity measurement between the respective cloud computing project and the reference cloud computing project comprises comparing a first value of a cloud computing project usage metric for the respective cloud computing project and a second value of the cloud computing project usage metric for the reference cloud computing project.

7. The method of claim 6, wherein the cloud computing project usage metric comprises at least one of a billing service metric, a number of application programming interface (API) calls, or an identity and access management (IAM) metric.

8. The method of claim 1, wherein determining the similarity measurement between the respective cloud computing project and the reference cloud computing project comprises comparing a first set of values of a plurality of cloud computing project usage metrics for the respective cloud computing project and a second set of values of the plurality of cloud computing project usage metrics for the reference cloud computing project.

9. The method of claim 8, wherein the plurality of cloud computing project usage metrics corresponds to more than one of a billing service metric, a number of application programming interface (API) calls, or an identity and access management (IAM) metric.

10. The method of claim 1, wherein the reference cloud computing project has zero project usage during a lifetime of the reference cloud computing project.

11. A system comprising:
data processing hardware; and
memory hardware in communication with the data processing hardware, the memory hardware storing instructions that when executed on the data processing hardware cause the data processing hardware to perform operations comprising:
receiving a plurality of cloud computing projects each associated with a client device of a cloud computing environment;
for each respective cloud computing project of the plurality of cloud computing projects associated with the client device of the cloud computing environment:
determining a similarity measurement between the respective cloud computing project and a reference cloud computing project; and
generating a respective project usage score for the respective cloud computing project based on the similarity measurement determined between the respective cloud computing project and the reference cloud computing project; and
communicating, to the client device of the cloud computing environment, one or more of the respective project usage scores generated for the plurality of cloud computing projects.

12. The system of claim 11, wherein:
the operations further comprise, for each respective cloud computing project, ranking the respective cloud computing project among the plurality of cloud computing projects based on the respective project usage scores generated for each respective cloud computing project; and
communicating the one or more respective project usage scores for the plurality of cloud computing projects to the client device comprises, for each respective cloud computing project, communicating the respective project usage score for the respective cloud computing project along with the ranking of the respective cloud computing project among the plurality of cloud computing projects.

13. The system of claim 11, wherein the operations further comprise:
determining that one of the plurality of cloud computing projects satisfies a project threshold based on the respective project usage score of the one of the plurality of cloud computing projects, the project threshold representing a predetermined activity level that corresponds to an active cloud computing project;
generating a remediation recommendation for the one of the plurality of cloud computing projects that satisfies the project threshold; and
communicating the remediation recommendation to the client device of the cloud computing environment.

14. The system of claim 13, wherein the remediation recommendation comprises a project cleanup recommendation.

15. The system of claim 13, wherein the remediation recommendation comprises a project inspection recommendation.

16. The system of claim 11, wherein determining the similarity measurement between the respective cloud computing project and the reference cloud computing project comprises comparing a first value of a cloud computing project usage metric for the respective cloud computing project and a second value of the cloud computing project usage metric for the reference cloud computing project.

17. The system of claim 16, wherein the cloud computing project usage metric comprises at least one of a billing service metric, a number of application programming interface (API) calls, or an identity and access management (IAM) metric.

18. The system of claim 11, wherein determining the similarity measurement between the respective cloud computing project and the reference cloud computing project comprises comparing a first set of values of a plurality of cloud computing project usage metrics for the respective cloud computing project and a second set of values of the plurality of cloud computing project usage metrics for the reference cloud computing project.

19. The system of claim 18, wherein the plurality of cloud computing project usage metrics corresponds to more than one of a billing service metric, a number of application programming interface (API) calls, or an identity and access management (IAM) metric.

20. The system of claim 11, wherein the reference cloud computing project has zero project usage during a lifetime of the reference cloud computing project.
